(19) United States
(12) Patent Application Publication
(10) Pub. No.: US 2017/0188746 A1
(43) Pub. Date: Jul. 6, 2017

(54) Reverse French Press

(71) Applicant: SCS Direct Inc., Trumbull, CT (US)

(72) Inventor: Benjamin Ebersold, Trumbull, CT (US)

(21) Appl. No.: 15/396,714

(22) Filed: Jan. 2, 2017

Related U.S. Application Data
(60) Provisional application No. 62/275,290, filed on Jan. 6, 2016.

(51) Int. Cl. A47J 31/38; A47J 31/44; A47J 31/00

(52) U.S. Cl. CPC A47J 31/38; A47J 31/002; A47J 31/4403

(57) ABSTRACT

A reverse French press has a brewer, carafe and optional lid. The brewer has a plunger, a vertical open top flask and a base with legs arranged about its bottom edge. The plunger has a vertical rod that goes through the center of the base with a horizontal filter at the top of the rod and a knob at the bottom of the rod. The legs form a space for the knob underneath the base. The filter extends above the top rim of the flask. Hot water and coffee are put in the flask below the filter. The carafe is then placed over the flask and sealed to the base. The assembly is turned upside down and the knob is pulled up pulling coffee grounds into the base. The brewer is then removed and brewed coffee remains in the carafe. The lid may then be put on the carafe.

### COPYRIGHT AND TRADEMARK NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### FIELD OF THE INVENTION

Embodiments of the present invention relate to coffee brewers.

### BACKGROUND OF THE INVENTION

French presses are devices for brewing coffee or other beverages requiring extraction of soluble chemicals from solids. One of the drawbacks of a French press is that coffee grounds are pushed to the bottom where they can continue to diffuse undesirable compounds into the coffee. This is a particular problem for travel French presses where the French press is taken by a user for consumption of the coffee later. There is need, therefore, for a French press that does not leave the coffee grounds in the bottom of the press after the coffee is brewed.

### SUMMARY OF THE INVENTION

The summary of the invention is provided as a guide to understanding the invention. It does not necessarily describe the most generic embodiment of the invention or the broadest range of alternative embodiments.

FIG. 1 illustrates a reverse French press 100. The reverse French press comprises a brewer 102 and a carafe 170. It may also comprise an optional lid 142. The brewer comprises a plunger 104, a flask 106 and a base 108. The plunger comprises a vertical rod 114, a horizontal filter 112 and a knob 116. The horizontal filter is attached to about the top end of the rod and the knob is attached to about the bottom end of the rod. The flask comprises an upper rim 105 and a bottom 107. The base comprises an open top 109 and a closed bottom 111.

The top of the base is joined to the bottom of the flask. The vertical rod passes through about the center of the bottom of the base and forms a sliding seal therewith. An elastomeric insert 136 may be provided in the bottom of the base for the rod to pass therethrough and form said sliding seal.

As used herein, a “seal” is a joint between two items that does not allow water or other liquid to readily pass through. A “sliding seal” is a seal that allows two items to slide past each other. A “reversible seal” is a seal that can be made and broken multiple times by mechanically moving two items together and apart.

The carafe has an open top 174 and a closed bottom 176. The carafe is dimensioned so that the flask of the brewer fits within the carafe when the carafe is turned upside down and placed over the brewer. Enough clearance is provided between the rim of the flask and the inside of the carafe to allow air to escape from the flask as the carafe is lowered. A suitable clearance is about 1.4 mm.

The top of the base of the brewer is adapted to form a reversible seal with the top of the carafe when the carafe is turned upside down and placed over the brewer. The top of the base may comprise a male closure 131 that mates with a female closure 173 near the top of the carafe. The male closure may comprise a male thread 132 and an elastomeric seal ring 130 above said male thread. The female closure may comprise a matching female thread 172 (FIG. 2) and a mating surface 176 (FIG. 2) below said female thread. Said mating surface is adapted to form said reversible seal with said elastomeric seal ring when said male thread is screwed into said female thread.

Alternatively, a female closure may be provided on the base of the brewer and a male closure may be provided near the top of the carafe. Other suitable reversible seals for the base of the brewer and the top of the carafe include twist and lock closures, flared fittings (e. g. corks or stoppers), “O” rings, quick disconnects, and compression fittings.

Referring again to FIG. 1, the bottom of the base of the brewer is described by a perimeter 113. A plurality of legs 134 extend down from the perimeter forming a knob space 138 therebetween. The knob space is indicated by dashed lines. The knob is dimensioned to fit within said knob space when the vertical rod is pushed up and the legs are placed on a horizontal surface. The horizontal filter will then be positioned above the upper rim of the flask forming a vertical clearance 135 between the horizontal filter and the upper rim of the flask. The vertical clearance should be at least 2 cm. Hot water and ground coffee can then be put through the vertical clearance and into the flask for brewing. An upward opening flare 128 may be provided at the upper rim of the flask to facilitate the introduction of hot water and ground coffee.

FIG. 2 shows a cross section of the brewer 102, lid 142, and carafe 170 of FIG. 1. The horizontal filter 112 may comprise a stiff frame 122, a filter mesh 124 and a flexible seal 126. The frame supports the filter mesh and the flexible seal. The flexible seal proceeds from the outer perimeter of the frame. For generally cylindrical flasks, the frame 122 will have an outer diameter 117 smaller than the internal diameter 139 of the flask 106 so that said frame easily fits inside said flask. The flexible seal 126 will have an outer diameter 115 slightly greater than the internal diameter of the flask so that said flexible seal will press against the inside of said flask and form a sliding seal as the filter is moved through the flask under the influence of the rod 114 and knob 116.

The flask 106 may be described by a height 127 and rim diameter 111. The base 108 may have an upward facing shoulder 137. The height of the flask is defined as the distance from the shoulder of the base to the rim 129 of the flask. The shoulder is low enough so that when the carafe 170 is inverted and the female thread 172 in the carafe is screwed on to the male thread 132 of the base, the seal ring 130 in the base can form a reversible seal with the mating surface 176 in the carafe.

The carafe may be described by an internal depth 171 and internal diameter 183. The internal depth of the carafe is measured from the inside bottom of the carafe 177 to the top of the carafe 174. In order for the flask to fit inside the carafe, the rim diameter of the flask must be smaller than the internal diameter of the carafe. Furthermore, the height of the flask must be less than the depth of the carafe.

A cross section of the insert 136, legs 134 and knob space 138 are shown in FIG. 2. The insert may be flexible enough to allow air to pass between the rod 114 and the insert when there is low pressure in the flask. This will be described in more detail with reference to FIG. 4A.

FIG. 2 further shows a simplified cross section of the lid 142. A latch 148 and lock 146 indicated in FIG. 1 are not shown. These will be described in more detail with reference to FIGS. 5A to 7B. The lid comprises a cap 144 on top of a bung 150. A plug 164 is provided in the roof of the cap. The bung comprises a spout 156. A vertical passage 162 proceeds from below the bung to above the spout. The spout and passage allow a user to drink brewed coffee or other beverage from the carafe when the lid is mounted on the carafe and the cap is opened. When the cap is closed, the plug presses against the spout forming a reversible seal.

The bottom of the bung may comprise a downward facing shoulder 153, male thread 152 and seal ring 154. These have about the same dimensions as the shoulder 137, male thread 132 and seal ring 130 of the top of the base 108. Thus the lid can be screwed onto the female thread of the carafe to form a reversible seal with the carafe.

The carafe may have insulation 178 in its walls. The insulation may be vacuum insulation or any other type of insulation.

The materials of construction for the reverse French press include any food suitable materials including metals (e.g. stainless steel), rigid plastics (e.g. polyethylene and polypropylene), flexible plastics (e.g. Tygon®), and elastomers (e.g. silicone rubber).

In operation, hot water and ground coffee are introduced into the brewer. The carafe is turned upside down, placed over the flask, and lowered. When the top of the carafe is lowered to the top of the base of the brewer, a reversible seal is made. The brewer-carafe assembly is then turned upside down and the knob is pulled up. The filter moves up as the knob is pulled up. This pulls coffee grounds up into the base of the brewer and leaves brewed coffee behind in the carafe. The brewer is then removed from the carafe taking the coffee grounds with it. The lid may then be put on the carafe for transporting the brewed coffee.

### BRIEF DESCRIPTION OF DRAWINGS

FIG. 1 is illustrates a reverse French press.

FIG. 2 is a vertical cross section of a brewer, lid and carafe.

FIG. 3A is a cross section of a brewer after hot water and ground coffee has been put in it.

FIG. 3B is a cross section of a carafe placed over the top of a brewer forming a brewer-carafe assembly.

FIG. 4A is a cross section of a brewer-carafe assembly turned upside down.

FIG. 4B is a cross section of a lid-carafe assembly.

FIG. 5A is a rendering of a lid from a side view.

FIG. 5B is a rendering of an exploded view of the lid of FIG. 5A.

FIG. 6 is a rendering of the latch and lock of FIG. 5B.

FIG. 7A is a rendering of a bottom side view of the cap of FIG. 5B.

FIG. 7B is a rendering of a bottom rear view of the cap of FIG. 5B.

### DETAILED DESCRIPTION

The detailed description describes non-limiting exemplary embodiments. Any individual features may be combined with other features as required by different applications for at least the benefits described herein.

As used herein, the term “about” means plus or minus 10% of a given value unless specifically indicated otherwise.

As used herein, the term “generally” when referring to a shape means that an item as the overall appearance of said shape even if there are minor variations from the pure form of said shape.

### Operation

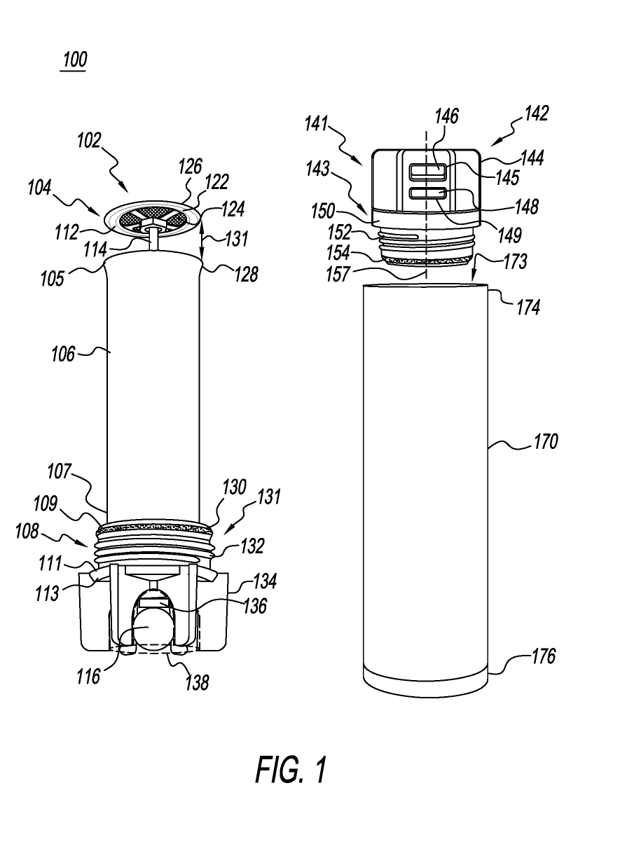

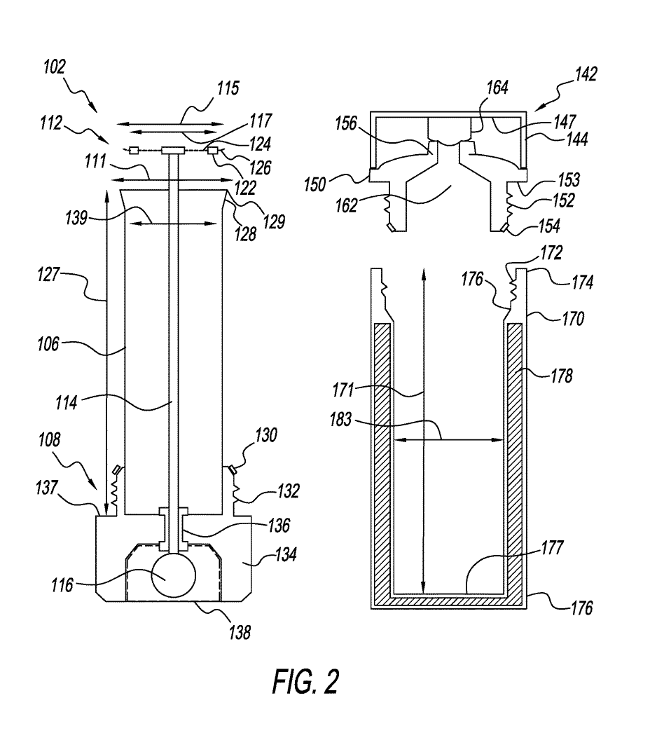

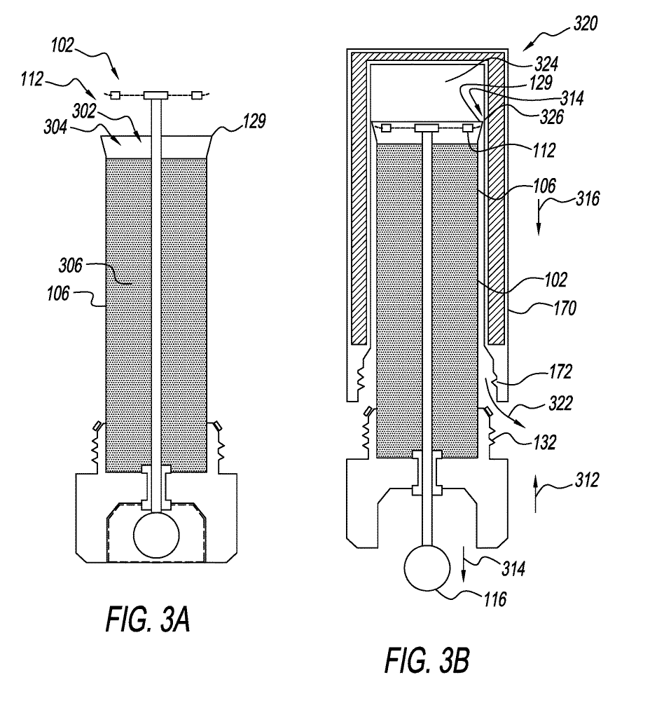

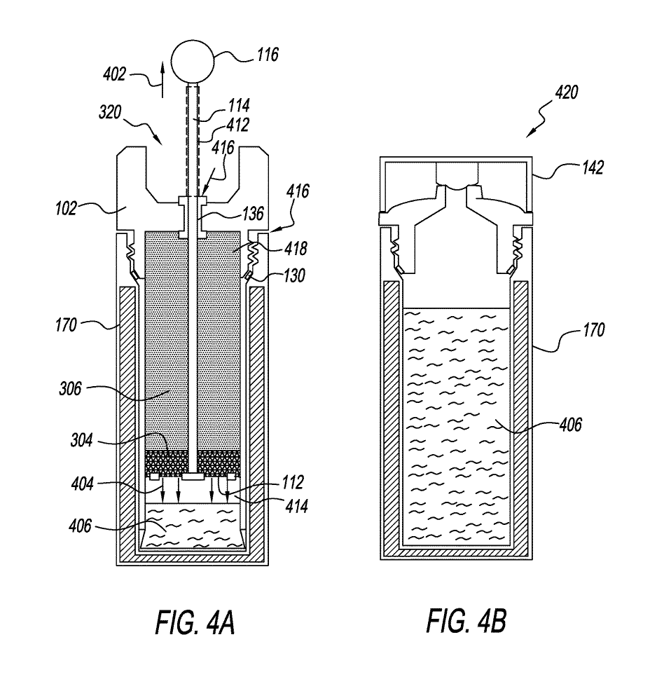

The operation of the reverse French press is illustrated in FIGS. 3A to 4B. FIG. 3A shows a cross section of the brewer 102 of FIG. 1. The filter 112 is above the rim 129 of the flask 106. Hot water 302 and ground coffee 304 have been introduced into the flask through the clearance between the filter and the rim. A mixture 306 of water and coffee is brewing in the flask.

FIG. 3B is a cross section of the carafe 170 being placed over the brewer 102 while the coffee is brewing. The user may initially lift up 312 the brewer and pull down 314 on the knob 116 so that the filter 112 is below the rim 129 of the flask 106. The user then picks up the carafe, inverts it, places it over the flask and lowers it 316. As described above, there is sufficient clearance 314 between the rim of the flask and the internal wall of the carafe 326 so that air can escape from the head space 324 above the rim and flow out 322 of the carafe as the carafe is lowered. Suitable clearance is 1 mm or larger. The carafe is lowered until the female thread 172 of the carafe can engage the male thread 132 of the base of the flask. The user then screws the threads together until a reversible seal is made. The joined brewer and carafe are referred to as a “brewer-carafe assembly” 320. The brewer-carafe assembly is then turned upside down.

FIG. 4A is a cross section of a brewer-carafe assembly after it has been turned upside down. The user then holds the carafe 170 and pulls 402 the knob 116 on the bottom end of the rod 114 of the brewer 102 up. This causes the filter 112 to move up through the mixture 306 of ground coffee and hot water. Coffee grounds 304 collect above the filter and filtered coffee 406 strains through 404 and collects in the bottom of the carafe.

As the rod is pulled up, a certain volume of rod 412 is removed from the inside of the brewer-carafe assembly 320. This can cause a reduced pressure in the inside of the brewer-carafe assembly depending upon how much residual air 414 there is in said brewer-carafe assembly. Replacement air 416, 418 may leak inside the brewer-carafe assembly thus relieving some of the reduced pressure if either of the elastomers in the insert 136 or seal ring 130 are soft enough and are under sufficiently low compression.

Once the knob is pulled all of the way up, the coffee grounds are held in the base of the brewer, filtered brewed coffee is in the carafe and the user can unscrew the brewer from the carafe and remove it. The user may then screw a lid on the brewer for transport thus forming a lid-carafe assembly.

FIG. 4B is a cross section of a lid-carafe assembly 420 after the user has screwed the lid 142 on the carafe 170. The brewed coffee 406 is then stored in the insulated carafe for transport and future consumption.

### Lid

Referring again to FIG. 1, the lid 142 comprises a top 141 and a bottom 143. The top of the lid may comprise a cap 144. The bottom of the lid may comprise a bung 150. The bung is adapted to form a reversible seal with the top 174 of the carafe 170. Said adaptation may comprise the above described male thread 152 and seal ring 154. The lid may also comprise the above described lock 146 and latch 148. Buttons on said lock and latch may protrude through corresponding upper 145 and lower 149 openings in the front of said cap.

The lid is generally symmetric about its front-to-back median plane 157. Thus when referring herein to left and right matched components of the lid, only one of said left or right matched components may be explicitly identified in a given figure.

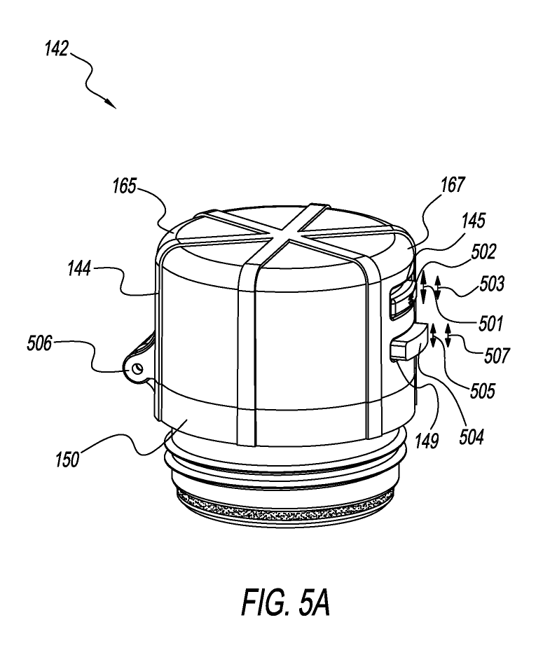

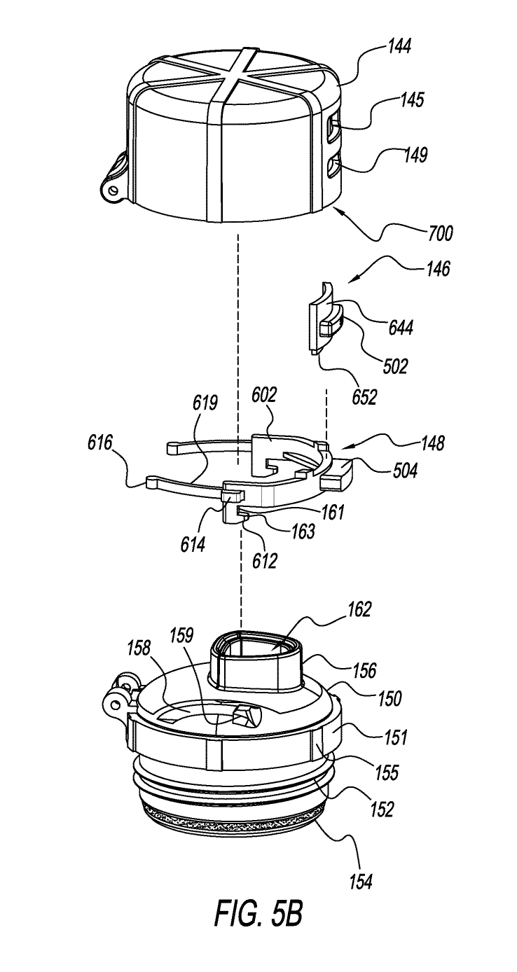

FIG. 5A shows a side rendering of the lid 142 of FIG. 1. FIG. 5B shows a vertically exploded rendering of a side view of the lid of FIG. 1. The top of the lid comprises a cap 144, a latch 148 and a lock 146. The lid has a front 167 and a back 165. The bottom of the lid comprises a bung 150. A hinge 506 in the back of the lid pivotably connects the bottom of the cap to the top of the bung. The latch comprises a latch button 504 which protrudes through a lower opening 149 in the front of the cap. The latch is adapted to hold the front of the cap onto the bung until the latch button is pressed in and the latch is released. The height 505 of the lower opening is about the same as the height 507 of the latch button since said button's motion is forward and back.

The lock serves to prevent the latch button from being accidentally pushed in when the cap is closed on the bung. The lock comprises a lock button 502 which protrudes through an upper opening 145 in the front of the cap. The height 501 of the upper opening is greater than the height 503 of the lock button. This allows the lock button to be pushed up and down. When the cap is closed, the lock button can be pushed down to prevent the latch button from being pushed back. When the lock button is pushed up, the latch button can be pushed in. In an alternative embodiment, the latch and/or the lock could be incorporated into the bottom of the lid. In another alternative embodiment, the lock button is to the side of the latch button. In another alternative embodiment, the lock button is below the latch button.

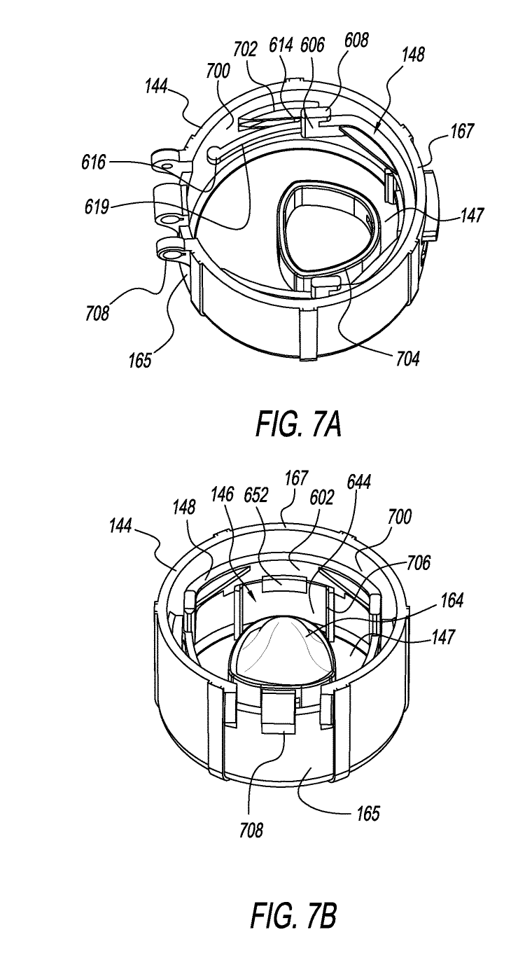

Referring to FIG. 5B, the bung 150 may comprise a spout 156. A vertical passage 162 proceeds from the top of the vertical spout to the bottom of the bung. This will allow a user to drink beverage in the carafe when the lid is joined to the carafe and the cap is open. A downward facing plug 164 (FIG. 7B) may be mounted in ceiling 147 (FIG. 7B) of the cap. The plug may be aligned with the spout so that it will form a reversible seal with the spout when the front of the cap is closed on the bung.

The bung may further comprise a grip 151, a male thread 152 below the grip and a seal ring 154 below the male thread. The male thread mates with a female thread in the top of the carafe. The grip has raised portions 155 to allow a user to grab and turn the bung to screw the male thread of the bung into the female thread of the carafe until the seal ring forms a reversible seal with the mating surface of the top end of the carafe.

The cap 144 may comprise a generally circular vertical inner wall 700 (FIG. 7A). The cap may further comprise left and right latch channels 702 (FIG. 7A) oriented front-to-back along the left and right inner sides of said generally circular vertical inner wall. The latch 148 has a generally arcuate shape to fit inside the vertical inner wall of the cap and around the spout of the bung. The latch comprises:
an arcuate stiff collar 602 extending about half way around the vertical inner wall of the cap;
left and right fingers 161 extending downward from the left and right ends of the collar;
left and right hooks 163 extending forward from the bottoms of said left and right fingers;
left and right side tabs 614 extending outwardly and horizontally from said left and right ends of said collar and into said left and right latch channels in said cap; and
left and right flexible arcuate bars 619 extending rearward from said left and right ends of said collar such that the distal ends of said left and right flexible arcuate bars contact and press against the back of said vertical inner wall of said cap thus pushing said latch button forward and through said lower opening.
   The bung comprises:
left and right finger channels 158 extending back-to-front on the left and right sides of the spout and aligned with the left and right fingers of the latch; and
left and right overhangs 159 that each cover a portion of the front end of said left and right finger channels such that said left and right hooks of said latch will sit in said finger channels and under said overhangs when the front of the cap is pressed down on the bung.

The hooks on said fingers may each comprise a front end with a forward and downward facing wedge 612. The wedges are aligned with the left and right overhangs on the finger channels in the bung such that the hooks will be pushed back and slide down past the overhangs when the front of the cap is pushed down on the bung.

The distal ends of the left and right flexible arcuate bars may each comprise an outward directed bump 616 which contacts the back of the inner vertical inner wall of the cap. The flexible bars must be bent in in order for the latch to fit in the cap. Thus the flexible bars are under compression and force the latch forward so that the latch button is pushed out of the lower opening in the cap.

The lock 146 may comprise a vertical back plate 644. The back plate comprising a left side, a right side, a top, a bottom, a front and a back. The lock button 502 is mounted on the front of the back plate. A lock tab 652 may be attached to said back of said back plate and extend below said bottom of said back plate. The cap may comprise left and right vertical lock channels 706 (FIG. 7B) in the front of said vertical inner wall 700 (FIG. 7B). The vertical lock channels may be dimensioned to receive the left and right sides of said back plate and allow the back plate to move up and down when the lock button is moved up and down. The lock tab is dimensioned to fit behind the collar of said latch when the lock button and hence the back plate is pushed down. The lock tab will then prevent the collar from moving backward when the latch button 504 is pushed in.

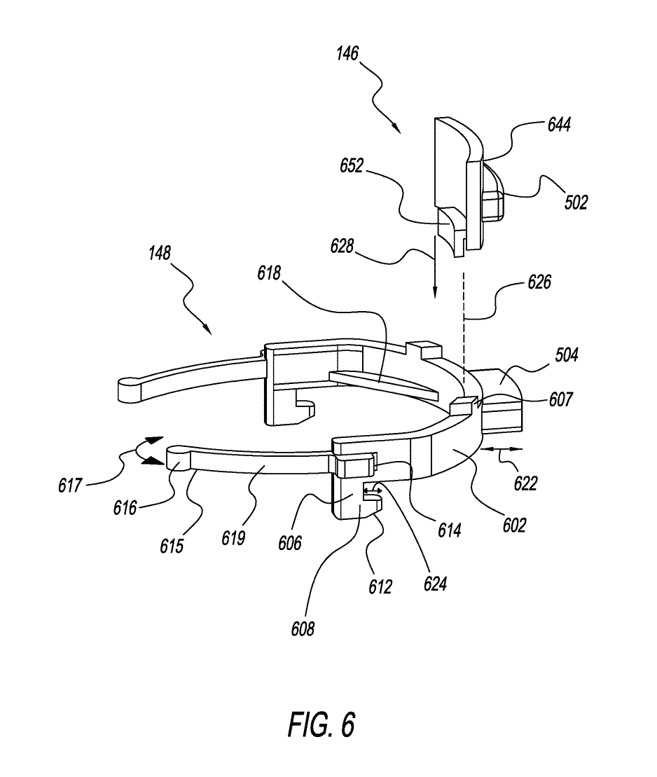

FIG. 6 is a rendering of the latch 148 and lock 146 of FIGS. 5A and 5B. The latch comprises the latch button 504, collar 602, left and right side tabs 614, left and right fingers 606, left and right hooks 608, left and right wedges 612, left and right flexible bars 619 and left and right bumps 616 attached to the distal ends 615 of the flexible bars. Left and right horizontal buttresses 618 may be provided at the back of the collar to further stiffen the collar. Left and right shoulders 607 may be provided on the top of the collar to help align 626 the lock 146 as it is pushed down 628 to secure the latch. The latch button may be described by a horizontal depth 622. The hook may be described by a horizontal depth 624. The depth of the latch button should be greater than the depth of the hook so that the hook can be pushed back far enough to clear the overhang of the finger channel in the bung when unlatching the cap from the bung.

The latch may be made from a single piece of rigid plastic. The bars 619 are flexible 617 relative to the collar 602 in part due to their smaller cross section relative to their length.

FIG. 7A shows a rendering of a side bottom view of the cap 144 of FIG. 5A. The latch 148 is shown mounted in the cap. The front 167 of the cap is on the right and the back 165 of the cap is on the left. A portion 708 of the rear hinge is shown. The left and right side tabs 614 of the latch sit in the left and right latch channels 702 of the cap. The left and right fingers 606 of the latch point up. The left and right hooks 608 point forward. The left and right flexible bars 619 are bent in and under compression so that the left and right bumps 616 at the distal ends of the flexible bars press against the back of the inner wall 700 of the cap. A plug mount 704 is shown in the ceiling of the cap. The plug mount is dimensioned to hold a flexible plug 164 (FIG. 7B) that will form a reversible seal with the spout of the bung when the front of the cap is closed on the plug.

FIG. 7B shows a rendering of a rear bottom view of the cap 144 of FIG. 5A. The front 167 and back 165 of the cap are indicated. The portion of the rear hinge 708 can be seen. The latch 148 and lock 146 are both mounted in the cap. The left and right sides of the back plate 644 of the lock are mounted in the left and right lock channels 706 of the cap. The lock is moved up (down if the cap were right side up) so that the lock tab 652 sits behind the collar 602 of the latch. Thus the collar cannot move back.

### CONCLUSION

While the disclosure has been described with reference to one or more different exemplary embodiments, it will be understood by those skilled in the art that various changes may be made and equivalents may be substituted for elements thereof without departing from the scope of the disclosure. In addition, many modifications may be made to adapt to a particular situation without departing from the essential scope or teachings thereof. Therefore, it is intended that the disclosure not be limited to the particular embodiment disclosed as the best mode contemplated for carrying out this invention.

We claim:

1. A reverse French press comprising:
a) a brewer comprising:
i) a plunger comprising:
1) a vertical rod comprising a top end and bottom end;
2) a horizontal filter mounted at about said top end of said rod; and
3) a knob attached to about said bottom end of said rod;
ii) a flask comprising an upper rim and a bottom; and
iii) a base comprising an open top and a closed bottom wherein:
1) said top of said base is joined to said bottom of said flask;
2) said vertical rod passes through about the center of said bottom of said base and forms a sliding seal with said bottom of said base; and
b) a carafe comprising an open top and a closed bottom wherein:
i) said flask fits within said carafe when said carafe is turned upside down and placed over said brewer; and
ii) said top of said base is adapted to form a reversible seal with said top of said carafe when said carafe is turned upside down and placed over said flask.

2. The reverse French press of claim 1 wherein said bottom of said base comprises:
a) a perimeter; and
b) a plurality of legs extending down from said perimeter forming a knob space therebetween such that said knob will fit within said knob space when said vertical rod is pushed up and said legs are placed on a horizontal surface.

3. The reverse French press of claim 2 wherein said horizontal filter is positioned above said upper rim of said flask forming a vertical clearance between said horizontal filter and said upper rim of said flask when said vertical rod is pushed up such that said knob is within said knob space.

4. The reverse French press of claim 3 wherein said vertical clearance is 2 cm or more.

5. The reverse French press of claim 3 wherein said upper rim of said flask comprises an upward opening flare.

6. The reverse French press of claim 1 wherein:
a) said top of said base comprises a male closure; and
b) said top of said carafe comprises a female closure that mates with said male closure of said base.

7. The reverse French press of claim 6 wherein:
a) said male closure of said base comprises:
i) a male thread; and
ii) an elastomeric seal ring above said male thread; and
b) said female closure of said top of said carafe comprises:
i) a female thread that matches said male thread; and
ii) a mating surface adapted for form a reversible seal with said elastomeric seal ring when said male thread is screwed into said female thread.

8. The reverse French press of claim 1 which further comprises a lid, wherein said lid comprises a top and a bottom and wherein said bottom of said lid is adapted to form a reversible seal with said top of said carafe.

9. The reverse French press of claim 8 wherein:
a) said top of said lid comprises a cap and a latch;
b) said cap comprises a front and a back;
c) said bottom of said lid comprises a bung;
d) said lid comprises a rear horizontal hinge which pivotably connects the bottom of said cap to the top of said bung; and
e) said latch comprises a latch button which protrudes through a lower opening in the front of said cap; and
f) said latch is adapted to hold said front of said cap down on said bung and release said front of said cap from said bung when said latch button is pushed in.

10. The reverse French press of claim 9 wherein:
a) said lid comprises a lock;
b) said lock comprises a lock button which protrudes through an upper opening in said cap;
c) the height of said upper opening is greater than the height of said lock button to allow said lock button to be pushed up and down; and
d) said lock is adapted to prevent said latch button from being pushed in when said lock button is pushed down; and
e) said lock is adapted to allow said latch button to be pushed in when said lock button is pushed up.

11. The reverse French press of claim 9 wherein
a) said cap comprises a downward facing plug;
b) said bung comprises:
i) a spout; and
ii) a vertical passage through said spout; and
c) said plug is aligned with said spout such that said plug with form a reversible seal with said spout when said front of said cap is closed on said bung.

12. The reverse French press of claim 9 wherein:
a) said cap comprises:
i) a generally circular vertical inner wall; and
ii) left and right latch channels oriented front-to-back along the left and right inner sides of said generally circular vertical inner wall;
b) said latch has a generally arcuate shape to fit inside of said vertical inner wall;
c) said latch comprises:
i) an arcuate stiff collar extending about half way around said vertical inner wall of said cap;
ii) left and right fingers extending downward from the left and right ends of said collar;
iii) left and right hooks extending forward from the bottoms of said left and right fingers;
iv) left and right side tabs extending outwardly and horizontally from said left and right ends of said collar and into said left and right latch channels in said cap; and
v) left and right flexible arcuate bars extending rearward from said left and right ends of said collar such that the distal ends of said left and right flexible arcuate bars contact and press against the back of said vertical inner wall of said cap thus pushing said latch button forward and through said lower opening; and
d) said bung comprises:
i) left and right finger channels extending back-to-front on the left and right sides of said spout and aligned with said left and right fingers of said latch; and
ii) left and right overhangs that each cover a portion of the front end of said left and right finger channels such that said left and right hooks of said latch will sit in said finger channels and under said overhangs when said front of said cap is pressed down on said bung.

13. The reverse French press of claim 12 wherein said hooks each comprise a front end with a forward and downward facing wedge aligned with said left and right overhangs such that said hooks will be pushed back and slide down past said overhangs when said front of said cap is pushed down on said bung.

14. The reverse French press of claim 12 wherein said distal ends of said left and right flexible arcuate bars each comprise an outward directed bump which contacts with said vertical inner wall of said cap.

15. The reverse French press of claim 12 wherein:
a) said lock comprises:
i) a vertical back plate comprising a left side, a right side, a top, a bottom, a front and a back; and
ii) a lock tab attached to said back of said back plate and extending below said bottom of said back plate; and
b) said cap comprises left and right vertical lock channels in the front of said vertical inner wall, said vertical lock channels being dimensioned to receive said left and right sides of said back plate
wherein:
c) said lock button is mounted on said front of said vertical back plate; and
d) said lock tab is dimensioned to fit behind said collar of said latch when said lock button is pushed down such that said lock tab will prevent said collar from moving backward when said latch button is pushed in.
